(19) United States
(12) Patent Application Publication
(10) Pub. No.: US 2003/0005834 A1
(43) Pub. Date: Jan. 9, 2003

(54) Process and apparatus for imaging surfaces in printing machines

(76) Inventor: Arndt Jentzsch, Coswig (DE)

Correspondence Address: GABRIEL P. KATONA, GOODWIN PROCTER L.L.P., 599 LEXINGTON AVENUE, 40TH FLOOR, NEW YORK, NY, 10022, US

(21) Appl. No.: 09/899,752

(22) Filed: Jul. 5, 2001

(30) Foreign Application Priority Data
Jul. 5, 2000 (DE) 100 32 703.6

(51) Int. Cl. B41M 1/14

(52) U.S. Cl. 101/211

(57) ABSTRACT

The invention relates to a method for imaging surfaces in printing presses, whereby the surfaces to be imaged contains image information of the preceding printing job.

Task of the invention is to realize a process and an apparatus for a fast and low-cost regeneration of surfaces carrying image information in printing presses.

The task is solved according the invention by applying an ink receptive layer carrying the actual image information on the ink-repelling imaging surface within one operation. The existing image information from the preceding printing job is erased during this operation by a preceding erasing unit

### FIELD OF INVENTION

The invention relates to a method for imaging surfaces, whereby the surfaces to be imaged contains image information of the preceding printing job. The printing machine has a least a printing form cylinder cooperating with an inking unit and possibly with a dampening unit and a blanket cylinder.

The invention relates furthermore to an apparatus for imaging surfaces in a printing press, where the printing machine has a least a printing form cylinder cooperating with a inking unit to be switched off and possibly with a dampening unit to be switched off, a blanket cylinder and a imaging unit for applying a the image information carrying layer.

### BACKGROUND OF INVENTION

A process for regenerating a preferably prior imaged printing form for offset printing is known from DE 41 23 959 C1. The regeneration of the printing plate consists of the image removal from the printing form and the make the printing form surface hydrophilic. Applying an ionized process gas through an applying device regenerates the printing form. The image is reactively erased and made hydrophilic simultaneously in one process step. A suction device removes the created gaseous products of this reaction.

The time consuming regeneration of the printing plate is disadvantageous.

### SUMMARY DESCRIPTION OF INVENTION

Task of the invention is to realize a process and an apparatus for a fast and low-cost regeneration of surfaces carrying image information in printing presses.

The task is solved according the invention by applying an ink receptive layer carrying the actual image information on the ink-repelling imaging surface within one operation. The existing image information from the preceding printing job is erased during this operation by a preceding erasing unit.

The advantage with this invention is the considerable reduction of make-ready time for printing presses.

### BRIEF DESCRIPTION OF THE DRAWING

The invention is described below in greater detail by an embodiment of the invention, by reference being had to the drawing, wherein:

FIG. 1: Schematic of the cylinder and roller allocation in a printing unit of an offset printing press with imaging unit

FIG. 2: Structure of the imaging unit

FIG. 3: Structure of the imaging unit in another embodiment

FIG. 4: Schematic of the cylinder and roller allocation in a printing unit of a sheet fed offset printing press with imaging unit and integrated coating unit

FIG. 5: Structure of the imaging unit according to FIG. 4

### DETAILED DESCRIPTION

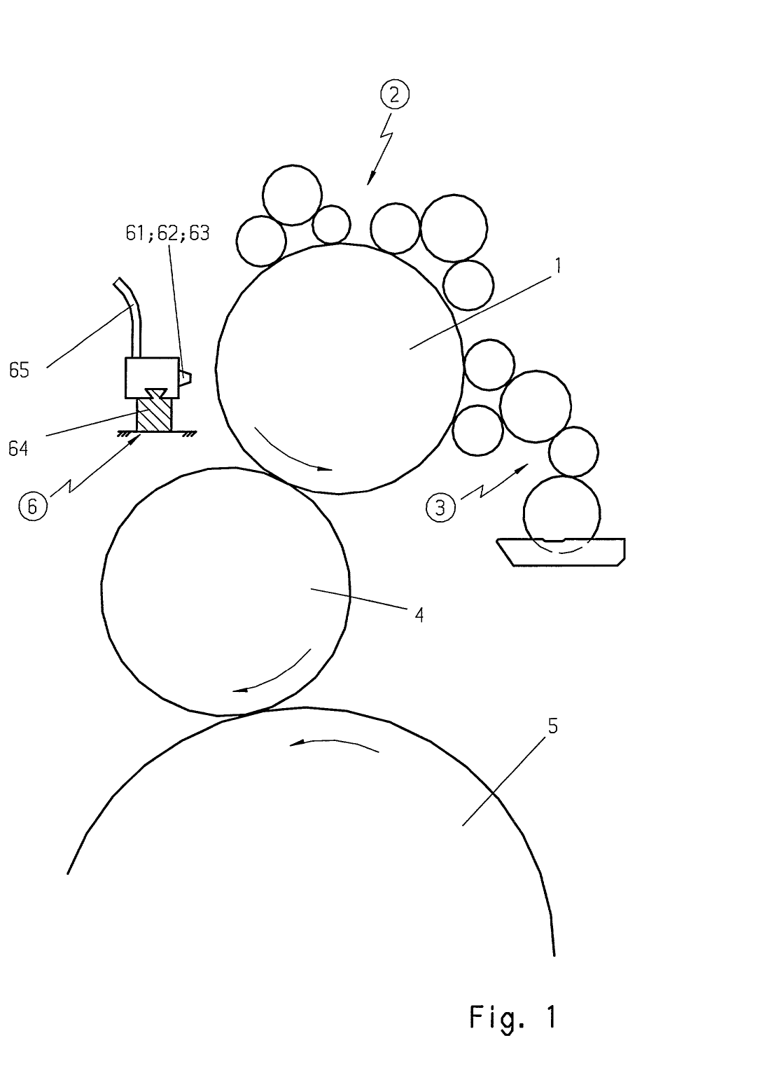

FIG. 1 shows the upper part of a printing tower of a sheet fed offset press with an impression cylinder 5, a blanket cylinder 4 and a printing form cylinder 1. These cylinders are together in contact during the printing process. An inking unit 2 and a dampening unit 3 are allocated to the printing form cylinder 1. Equipment not shown can remove inking unit 2, dampening unit 3 and blanket cylinder 4 from the contact with the printing form cylinder 1 if required. The printing form cylinder can also carry a not shown printing plate to take the image. It is also possible to put a sleeve on the printing form cylinder 1.

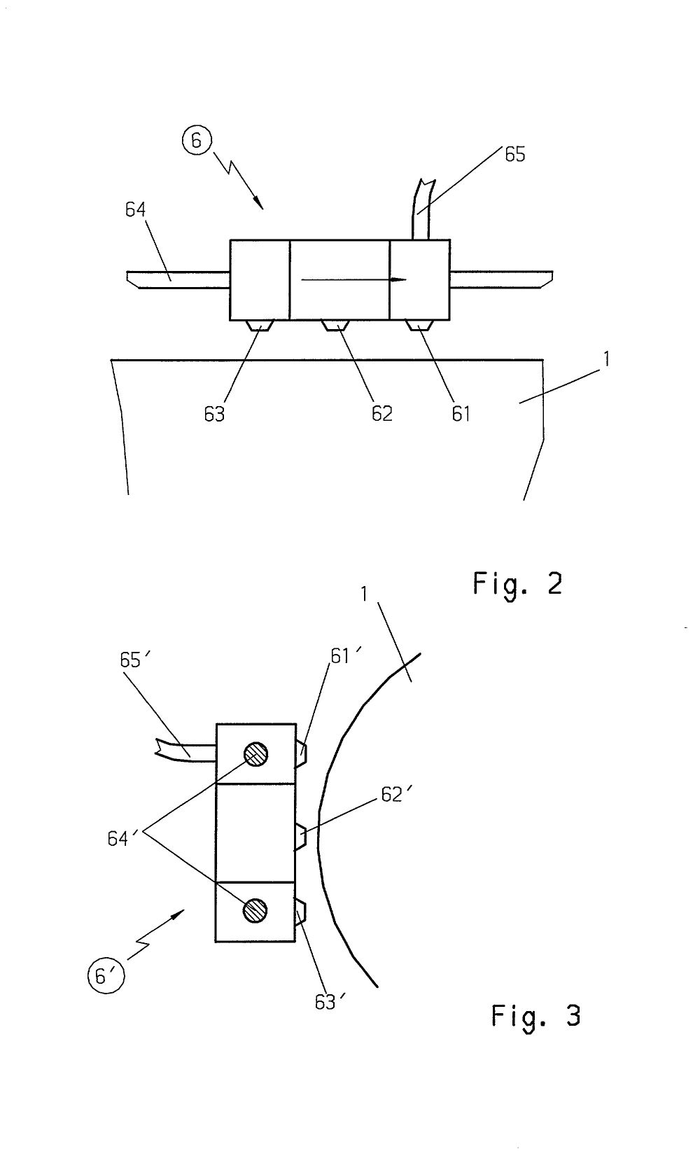

An imaging unit 6 is allocated to the printing form cylinder 1. This imaging unit 1 transverses axially to printing form cylinder 1 on a crossbar 64 and is mounted in the frame of the printing press. FIG. 2 shows the structure of such an imaging unit 6.

Main part of the imaging unit 6 is image creation unit 62. The creation unit 62 operates in the embodiment with ink-jet principle. It is also possible to use other application devices. One not shown embodiment uses a laser radiated transfer foil.

The image creation unit 62 has an erasing unit 61 integrated into the imaging unit 6 in the direction of the motion (arrow in FIG. 2) of the imaging unit 6. The erasing unit 61 consists of a laser with a suction device 65. A hardening unit 63 follows the image creation unit 62. The hardening unit 63 uses a laser. It is also possible to use UV light instead of the laser.

In another embodiment of the invention (FIG. 3) the integrated erasing unit 61′, die image creation unit 62′ and the hardening unit 63′ are mounted one after another in the direction of the motion (arrow in FIG. 3) of the printing form cylinder 1. The erasing unit 61′ has a suction device 65′. The imaging unit 6′ transverses axially analogue to the imaging unit 6 axial on a crossbar 64′.

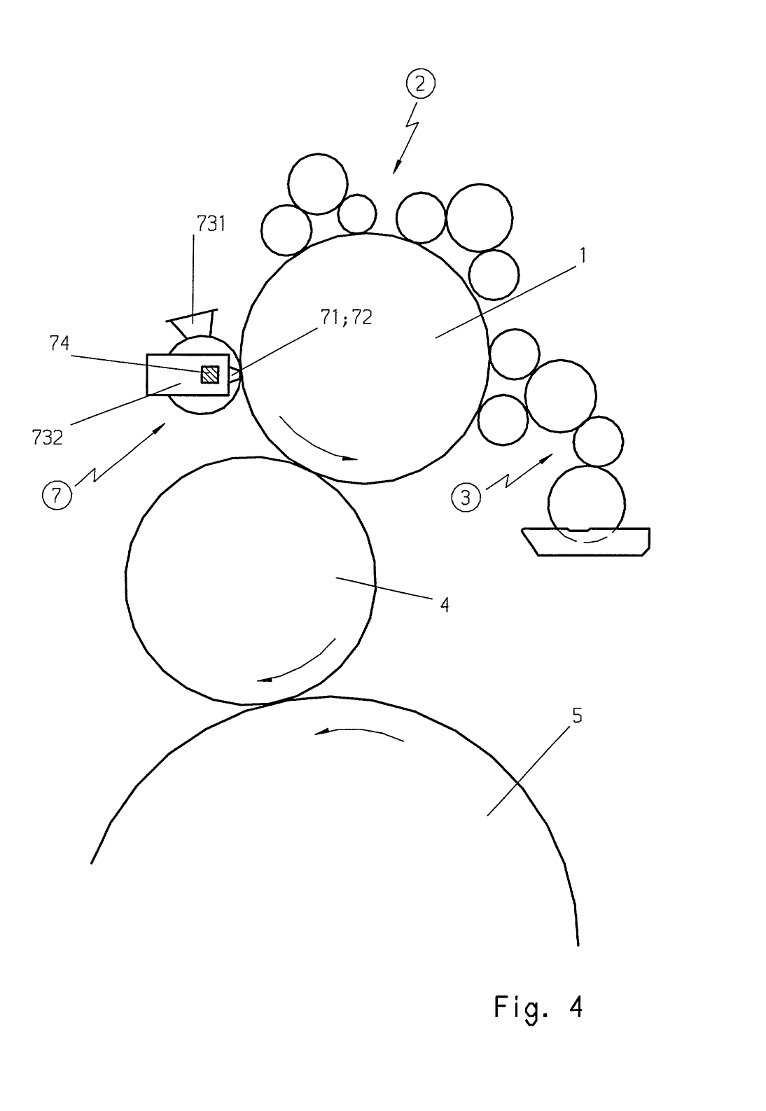

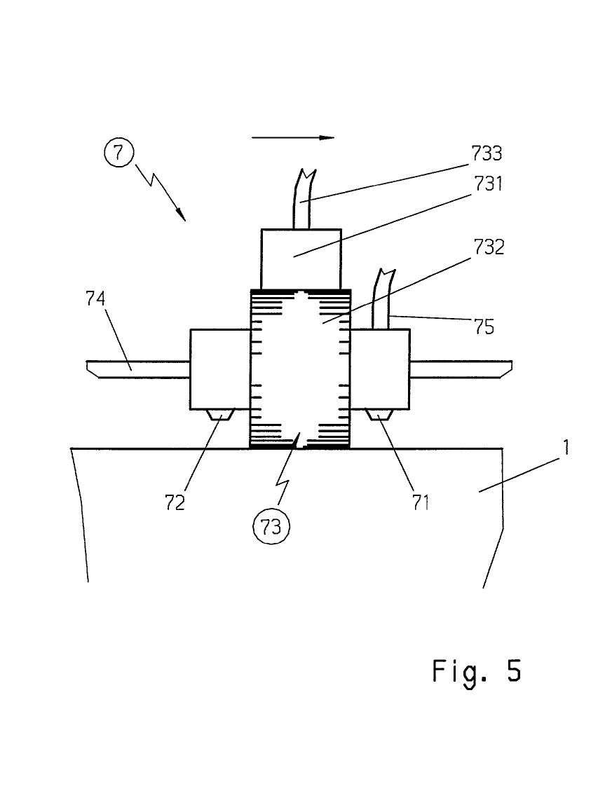

FIG. 4 shows together with FIG. 5 a further embodiment of the invention. An imaging unit 7 is axially transversing on a crossbar 74. The imaging unit 7 consists of a coating unit 73 with a preceding erasing unit 71 including suction device 75. An image creation unit 72, whereby also a not shown hardening unit can be allocated, follows the coating unit 73. The image creation unit 72 is embodied as an ablation laser.

The coating unit 73 consists of a screened roller 732 with a doctor blade 731, including the necessary supply lines 733. Other coating devices for instance spray devices can also be used.

The erasing unit 71, the coating unit 73 and the image creation unit 72 can also be arranged one after another in the rotational direction of the printing form cylinder 1.

The invented process is realized in the following manner:

The printing unit including the printing form cylinder 1 is washed down after a printing job is finished. The inking unit 2, the dampening unit 3 and the blanket cylinder 4 are removed from contact with the printing form cylinder 1. It also possible to remove the printing form cylinder 1.

The imaging of the printing form cylinder 1 respectively the printing plate or the sleeve starts afterwards. The data is provided by a digital memory.

At the beginning of the imaging process the imaging unit 6 is outside of the printing area at the outer edge of the printing form cylinder 1. The imaging unit 6 moves in axial direction (arrow in FIG. 2) for imaging. The laser of the erasing unit 61 hits layer from the preceding printing job. This layer evaporates through the laser and is sucked off by the suction device 65.

The erased zones of the printing form cylinder 1 are now reaching the range of the image creation unit 62 by the axial movement of the imaging unit 6. The image creation unit applies a coating containing the image information to the printing form cylinder 1.

In one embodiment the coating in made with an ink receptive coating material on the ink-repelling surface of the printing form cylinder 1 or the surface of the printing form. Thus the ink receptive layer carries the image information of the actual printing job.

In another embodiment the coating is made with ink repelling coating material on an ink receptive surface. The image carrying elements are here the non-coated areas of the surface of the printing form cylinder 1 or the printing form.

The coating material is applied through ink-jet in one step to the surface to be coated. In another variant the layer carrying the image information is applied to the image surface by a transfer foil in cooperation with a laser. The medium on the transfer foil is transferred from the transfer foil to the image surface by the thermal impact of the laser.

During the continued movement of the imaging unit 6 the coated zones are getting to the hardening unit 63, which hardens the layer by laser or UV light.

The process goes on continually until the imaging unit 6 reaches the other side of is the printing form cylinder 1.

The coating is finished within one operating step and the printing of the new printing job can start. The inking unit 2, the dampening unit 3 and possibly the blanket cylinder 4 are now engaged for this purpose to the printing form cylinder 1. The printing form cylinder 1 will be engaged too if applicable. Now the inking of the printing plate respectively of the surface of the printing form cylinder 1 can start and the actual printing job can be printed.

The invented process can also be realized with the apparatus shown in FIG. 4. The existing image information is erased, the actual image information is transferred and hardened in one track by the arrangement of erasing unit 61′. The image creation unit 62′ and hardening unit 63′ are rectangular to the axis of the printing form cylinder 1.

The apparatus shown in FIG. 4 and FIG. 5 can also be realized a further embodiment of the invention. In this process the imagable layer is transferred to the printing form cylinder in the following manner:

The erasing unit 71 removes the existing image carrying layer from the surface of the printing form cylinder respectively from the printing plate. The remaining are sucked off. The coating unit 73 applies a coating to the surface of the printing form cylinder 1 respectively to printing plate during the movement of the imaging unit 7.

In another variant of this embodiment an ink receptive layer is applied to the coated surface within one step. The surface is ink repelling in this case.

Afterwards the layer is receives the image by the image creation unit 72 and is hardened if applicable. During this process the ink receptive layer is removed in the no image carrying areas by an ablation laser, so that the ink repelling surface of the printing form cylinder respectively the printing plate is laid bare. This process can be combined advantageously with erasing and coating of image layer. It can also be made in a separate operating cycle.

In another embodiment the ink-repelling layer is put on top of the ink receptive surface of the printing form cylinder respectively the printing plate. The imaging removes now the ink-repelling layer in the image carrying areas, so that the ink receptive surface is laid bare.

Now the actual printing of the printing job can start. The inking unit 2, the dampening unit 3 and the blanket cylinder 4 if applicable are engaged to the printing form cylinder 1. The printing form cylinder 1 is engaged too if applicable. The usual inking of the printing pate respectively of the surface of the printing form cylinder 1 begins and the printing job can proceed.

We claim:

1. Process for imaging of surfaces in printing presses with the imaging surfaces carrying image information from preceding printing job for printing presses with at least one printing form cylinder cooperating with an inking unit, possibly a dampening unit and possibly a blanket cylinder and imaging whereby
the inking unit and dampening unit are disengaged from the printing form cylinder
an ink receptive layer carrying the actual image information is applied to the ink-repelling surface to take the image within one step, during which
the preceding erasing unit erases the existing image information from the preceding printing job during the afore mentioned step and
the printing process is initiated.

2. Process for imaging of surfaces in printing presses with the imaging surfaces carrying image information from preceding printing job for printing presses with at least one printing form cylinder cooperating with an inking unit, possibly a dampening unit and possibly a blanket cylinder and imaging whereby
the inking unit and dampening unit are disengaged from the printing form cylinder
an ink-repelling layer carrying the non-image information is applied to ink receptive surface to take the image within one step, during which
the preceding erasing unit erases the existing layer information from the preceding printing job during the afore mentioned step and
the printing process is initiated.

3. Process for imaging of surfaces in printing presses according to claim 1 and 2 whereby
the application of the layer to the imaging surface is made with an ink-jet process.

4. Process for imaging of surfaces in printing presses according to claim 1 and 2 whereby
the application of the layer to the imaging surface is made with transfer foil cooperating with a laser, where the laser transfers the medium on the transfer foil to the imaging surface.

5. Process for imaging of surfaces in printing presses according to claim 1 and 2 whereby
the layer is hardened by a subsequent hardening unit during the imaging.

6. Process for imaging of surfaces in printing presses according to claim 1 and 2 whereby
the hardening of the layer is provided with a laser.

7. Process for imaging of surfaces in printing presses according to claim 1 and 2 whereby
the hardening of the layer is provided with UV light.

8. Process for imaging of surfaces in printing presses with the imaging surfaces carrying image information from preceding printing job for printing presses with at least one printing form cylinder cooperating with an inking unit, possibly a dampening unit and possibly a blanket cylinder and imaging whereby
the inking unit and dampening unit are disengaged
an ink receptive imaging layer is applied to the ink-repelling imaging surface within one step,
the preceding erasing unit erases the existing layer from the preceding printing job during the afore mentioned step and
the imaging layer receives the actual image information by an ablation laser by removing the non-image carrying areas of the layer,
the inking unit and dampening unit are engaged and
printing process is initiated.

9. Process for imaging of surfaces in printing presses with the imaging surfaces carrying image information from preceding printing job for printing presses with at least one printing form cylinder cooperating with an inking unit, possibly a dampening unit and possibly a blanket cylinder and imaging whereby
the inking unit and dampening unit are disengaged
an ink repelling layer is applied to the ink receptive imaging surface within one step,
the preceding erasing unit erases the existing layer from the preceding printing job during the afore mentioned step and
the imaging layer receives the actual image information by an ablation laser by removing the image carrying areas of the layer,
the inking unit and dampening unit are engaged and
printing process is initiated.

10. Process for imaging of surfaces in printing presses according to claim 8 and 9 whereby
the erasing of existing image information and application of the image carrying layer is provided in one operation.

11. Process for imaging of surfaces in printing presses according to claim 8 and 9 whereby
the layer is hardened during its application by a subsequent hardening unit.

12. Process for imaging of surfaces in printing presses according to claim 8 and 9 whereby
the hardening is provided by UV light.

13. Process for imaging of surfaces in printing presses according to claim 1, 2, 8 and 9
whereby
the blanket cylinder is disengaged from the printing form cylinder during imaging.

14. Process for imaging of surfaces in printing presses according to claim 1, 2, 8 and 9
whereby
the printing form cylinder is disengaged during imaging.

15. Process for imaging of surfaces in printing presses according to claim 1, 2, 8 and 9
whereby
the imaging is made on the surface of the printing form cylinder or on the surface of a printing form mounted on the printing form cylinder with the printing form embodied as a sleeve.

16. Process for imaging of surfaces in printing presses according to claim 1, 2, 8 and 9
whereby
the erasing of the existing image information is made by a laser.

17. Process for imaging of surfaces in printing presses according to claim 1, 2, 8 and 9
whereby
the remainings of the erasing are sucked off by a subsequent unit.

18. Apparatus for imaging of surfaces in printing presses with at least one from printing form cylinder disengageable inking unit, possibly a disengageable dampening unit cooperating with the printing form cylinder, possibly a blanket cylinder cooperating with the printing form cylinder and imaging unit with an image creation unit for applying image information to the image and non-image carrying layers
whereby
the imaging unit has an erasing unit preceding the imaging unit in the direction of its motion.

19. Apparatus for imaging of surfaces in printing presses according to claim 18 whereby
a device for disengaging the blanket cylinder from the printing form cylinder is provided.

20. Apparatus for imaging of surfaces in printing presses according to claim 18 whereby
an image creation unit applies the layer carrying the image information with the ink-jet principle.

21. Apparatus for imaging of surfaces in printing presses according to claim 18 whereby
a device applies the image information carrying layer with laser radiated transfer foil.

22. Apparatus for imaging of surfaces in printing presses according to claim 18 whereby
a hardening unit for hardening the layer carrying the image information is integrated in the imaging unit.

23. Apparatus for imaging of surfaces in printing presses with at least one from printing form cylinder disengageable inking unit, possibly a disengageable dampening unit cooperating with the printing form cylinder, possibly a blanket cylinder cooperating with the printing form cylinder, a transversing imaging unit with an image creation unit for applying a layer and a ablation laser for imaging surfaces
whereby
the imaging unit has an integrated erasing unit preceding the coating unit in the direction of motion.

24. Apparatus for imaging of surfaces in printing presses according to claim 23 whereby
the imaging is made on the surface of the printing form cylinder or on the surface of a printing form mounted on the printing form cylinder with the printing form embodied as a sleeve.

25. Apparatus for imaging of surfaces in printing presses according to claim 23 whereby
a hardening unit is integrated in the imaging unit.

26. Apparatus for imaging of surfaces in printing presses according to claim 23 whereby
a suction device is integrated in the imagining unit.

27. Apparatus for imaging of surfaces in printing presses according to claim 23 whereby
a doctor blade system is provided for applying the coating material to the surface to take the image.

28. Apparatus for imaging of surfaces in printing presses according to claim 23 whereby
coating material for the imaging layer is applied by a spraying device.

29. Apparatus for imaging of surfaces in printing presses according to claim 18 and 23
whereby
the integrated erasing unit is embodied as a laser.

30. Apparatus for imaging of surfaces in printing presses according to claim 18 and 23
whereby
a suction device for removing remainings of the erasing is integrated in the imaging unit.
